(19) United States
(12) Patent Application Publication
(10) Pub. No.: US 2022/0230793 A1
(43) Pub. Date: Jul. 21, 2022

(54) Electromagnetic force driven apparatus

(71) Applicant: En-Chih Wu, Kaohsiung (TW)

(72) Inventor: En-Chih Wu, Kaohsiung (TW)

(21) Appl. No.: 17/564,201

(22) Filed: Dec. 28, 2021

(30) Foreign Application Priority Data
Jan. 21, 2021 (TW) 110102380

(51) Int. Cl. H01F 7/06; G05B 13/02

(52) U.S. Cl. CPC H01F 7/064; G05B 13/024

(57) ABSTRACT

An apparatus for cutting electromagnetic force, converting same and maintaining stable properties includes a rotational member in a housing. The housing includes an environment control device and at least one permanent magnet on an inner surface of the housing. The environment control device and the housing are electrically connected to an electric source. The environment control device includes a thermostat, a pressure controller, an emission unit for emitting ultrasound, and an illumination unit for emitting light. The thermostat, the pressure controller, the emission unit, and the illumination unit are electrically connected to the electric source. The thermostat is electrically connected to a cooling unit which flows low temperature gas to at least one conductive ball to suddenly decrease a temperature of each. The rotational member is connected to each one ball. The rotational member controls a rotation of each ball.

### BACKGROUND OF THE INVENTION

### 1. Field of the Invention

The invention relates to apparatuses and more particularly to an apparatus for quickly changing quantum force of particles of a material by cutting electromagnetic force, converting same and maintaining stable properties.

### 2. Description of Related Art

It is typical of applying electromagnetic force to a liquid such as wine, tea, enzyme, soybean sauce, water, etc. or a solid at set strict conditions and after a set period of time has passed, the liquid or solid material may be catalyzed to change quantum force of the liquid or solid material at a certain probability. Thus, the liquid or solid material having changed quantum force may be converted into an optimized product which is widely enjoyed by people in our daily life. For example, after has been brewed and after a period of ripening time, wine becomes more tasty. It is found that wine ripen for five years is more tasty when consumed. Further, wines ripen for eight to ten years become tastier when consumed. Thus, old wines are exemplary examples of changing quantum force of a material in our daily life and are typical examples of application of optimizing properties of a material.

However, typically, at strict set conditions it takes a very long time for a material to change properties of its particles prior to obtaining an optimized product. Thus, it is desired to provide an apparatus for cutting electromagnetic force, converting same and maintaining stable properties by greatly decreasing time required to change quantum force of particles of a material so as to obtain an optimized product.

### SUMMARY OF THE INVENTION

It is therefore an object of the invention to provide an apparatus for cutting electromagnetic force, converting same and maintaining stable properties by greatly decreasing time required to change quantum force of particles of a material.

To achieve above and other objects of the invention, the invention provides an apparatus for cutting electromagnetic force, converting same and maintaining stable properties, comprising a housing and a rotational member wherein the housing is a multi-sided member and includes an environment control device and at least one permanent magnet each disposed on an inner surface of the housing; the housing is formed of metallic conductive material; the environment control device and the housing are electrically connected to an electric source; the environment control device includes a thermostat for automatically regulating an internal temperature of the housing, a pressure controller for automatically controlling an internal pressure of the housing, an emission unit for emitting ultrasound, and an illumination unit for emitting light wherein the thermostat, the pressure controller, the emission unit, and the illumination unit are electrically connected to the electric source; the thermostat is electrically connected to a cooling unit which is configured to flow low temperature gas to at least one ball to suddenly decrease a temperature of each of the at least one ball; and the rotational member is disposed in the housing and electrically connected to the electric source; the rotational member is connected to each of the at least one ball which is conductive; and the rotational member is configured to control a rotation of each of the at least one ball and supply electricity thereto.

Preferably, the number of the at least one ball is at least two; and the number of the balls is a multiple of two; and the rotational member is configured to control rotations of the balls in opposite directions or the same direction.

The invention further provides a method of cutting electromagnetic force, converting same and maintaining stable properties. The method is tied to the apparatus and comprises steps of preparation, input and activation, cooling, and output wherein the step of preparation involves setting parameters of the thermostat, the pressure controller, the emission unit and the illumination unit in the housing of the apparatus; setting electrical parameters of the balls; and the electrical parameters of the housing in which regarding the settings, the internal temperature of the housing is regulated at a range between −20° C. and 100° C. and the internal pressure of the housing is controlled at a range between 4 and 16 Pa; the current and the voltage of the housing is set at 0.1-4 A and 240-340V respectively; and the current and the voltage of the ball is set at 0.1-6 A and 5-30V respectively so that the quantum force of the material can be changed to an optimum value; the step of input and activation involves after inputting the material (e.g., liquid or solid) to the apparatus, the apparatus is activated. Next, in the apparatus, the thermostat automatically regulates the internal temperature of the housing, the pressure controller automatically controls the internal pressure of the housing, the emission unit emits ultrasound toward the material, and the illumination unit emits light toward the material. Thus, the permanent magnet generates a magnetic field on an inner surface of the housing and the balls are conducted and rotate to cut the magnetic field to bring about a magnetic effect. The quantum force changes includes the energy of the material changed, cut, penetrated, separated, entangled and stacked due to the cutting of the magnetic field; the step of cooling involves after the set activation time has passed, the cooling unit suddenly cools the balls so that temperature of the material of the housing, which has been changed in quantum force, also suddenly decreases. The cooling unit cools the housing to a temperature between 0° C. and −20° C. Thus, the cooled, quantum force changed material returns to a normal stable energy stage which can maintain stable properties; and the step of output involves outputting the quantum force changed material having stable properties. As a result, the material becomes an optimized material having stable properties after its quantum force has been changed.

The apparatus for cutting electromagnetic force, converting same and maintaining stable properties of the invention and its application method have the following advantageous effects in comparison with the prior art:

A difference of rotational angles of the conductive balls, and a difference of rotational angle the conductive balls rotating in different directions in the conductive housing influenced by the magnetic field are utilized. Thus, an effect of electromagnetic force of the material is brought about by the conductive balls and the conductive housing influenced by the magnetic field. The effect of electromagnetic force causes particles of the material to change, cut, penetrate, separate, entangle and stack the energy of the material due to the cutting of the magnetic field. Thus, the material having quantum force changes is in an activated energy stage.

During the process of changing quantum force of the material, the thermostat automatically regulates the internal temperature of the housing to increase or decrease the speed of quantum force change of the material, the pressure controller automatically controls the internal pressure of the housing to be near vacuum to prevent the material from being interfered by impure particles in the air, the emission unit emits ultrasound toward the material so that the material is further activated to facilitate the change of quantum force, and the illumination unit emits light toward the material to change an energy structure of the particles of the material. Next, the cooling unit suddenly decreases temperature of the activated material having its quantum force change so that the material returns to a stable energy stage which is an energy stage that can maintain stable properties. Finally, the material becomes an optimized material having stable properties after its quantum force has been changed.

By inputting the material to the apparatus of the invention, the quantum force change of the material can be made quickly so that a material having stable properties is produced. And in turn, the process of changing quantum force can be carried out by setting and adjusting parameters. Further, an optimum control is carried out. In such a manner, the change of quantum force can be carried out by setting and adjusting parameters. Furthermore, the time and cost of changing properties of the liquid or solid material by changing quantum force can be optimized.

The above and other objects, features and advantages of the invention will become apparent from the following detailed description taken with the accompanying drawings.

### BRIEF DESCRIPTION OF THE DRAWINGS

FIG. 1 schematically depicts an apparatus for cutting electromagnetic force, converting same and maintaining stable properties according to the invention;

FIG. 2 is a view similar to FIG. 1 showing the two balls rotating in the same direction;

FIG. 3 is a view similar to FIG. 1 showing the two balls rotating in opposite direction; and

FIG. 4 is a flow chart of an application method tied to the apparatus for cutting electromagnetic force, converting same and maintaining stable properties according to the invention.

### DETAILED DESCRIPTION OF THE INVENTION

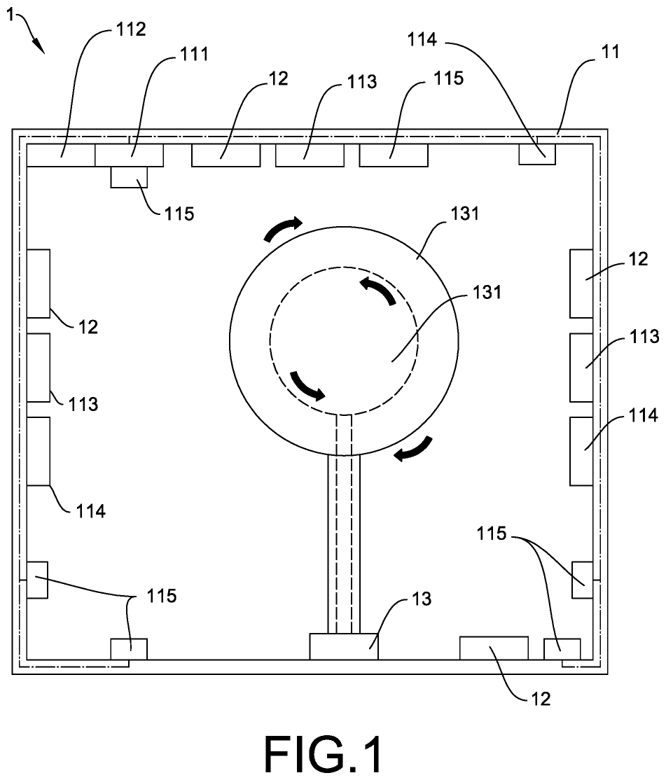

Referring to FIG. 1, an apparatus 1 for cutting electromagnetic force, converting same and maintaining stable properties in accordance with the invention comprises a housing 11 and a rotational member 13 as discussed in detail below.

The housing 11 is a multi-sided member and includes an environment control device (not shown) and a plurality of permanent magnets 12 each disposed on an inner surface of the housing 11. The housing 11 is made of metallic conductive material. The environment control device and the housing 11 are electrically connected to an electric source (not shown) so that the environment control device can be activated and the housing 11 can be conducted.

The environment control device includes a thermostat 111 for automatically regulating temperature of inside of the housing 11, a pressure controller 112 for automatically controlling internal pressure of the housing 11, an emission unit 113 for emitting ultrasound, and an illumination unit 114 for emitting light. The thermostat 111, the pressure controller 112, the emission unit 113 and the illumination unit 114 are electrically connected to the electric source. Further, the thermostat 111 is electrically connected to a cooling unit 115 which is adapted to flow low temperature gas to a ball 131 so that temperature of the ball 131 may decrease suddenly. A rotational member 13 is disposed in the housing 11 and is electrically connected to the electric source. The rotational member 13 is connected to at least one conductive ball 131. The rotational member 13 may control a rotation of each ball 131 and supply electricity to the ball 131.

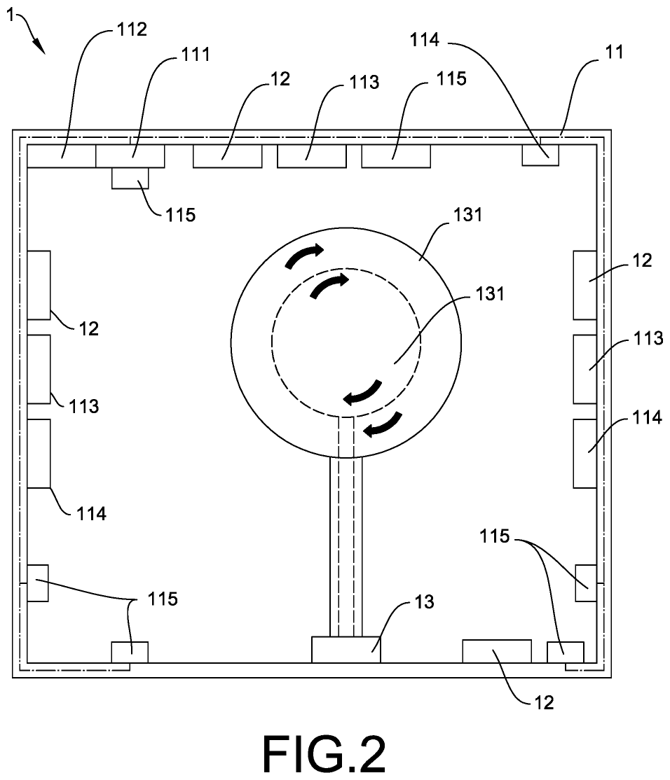

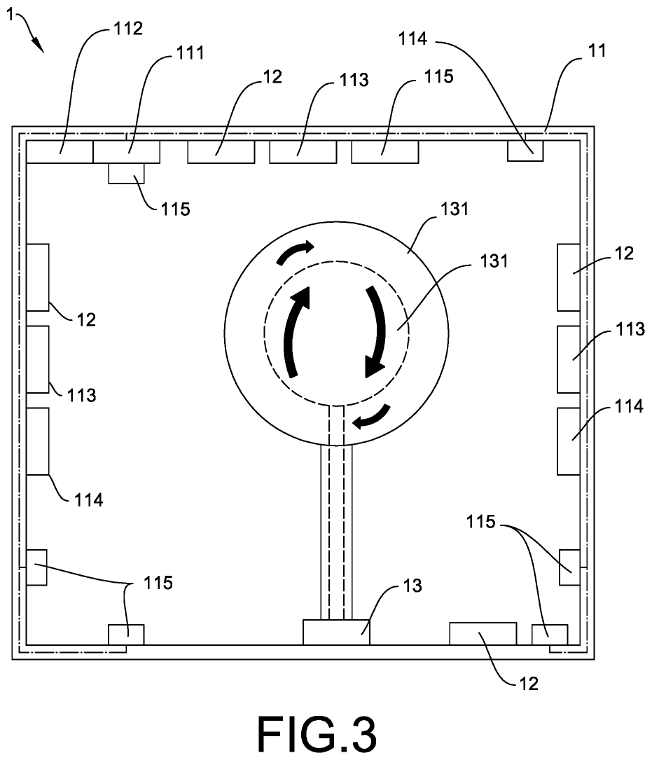

Referring to FIGS. 2 and 3 in conjunction with FIG. 1, the number of the balls 131 is at least two and preferably, the number of the balls 131 is two. The rotational member 13 may activate to control rotation of the ball 131 in a single axis (e.g., X-axis) or two different axes (e.g., X-axis and Y-axis) in different directions or the same direction. In FIG. 1, the balls 131 rotate in opposite directions. In FIG. 2, the balls 131 rotate in the same direction. A rotational direction difference of the balls 131 increases greatly when the balls 131 rotate in opposite directions. The balls 131 rotating in the opposite directions may generate a great change of electromagnetic force when the balls 131 rotate in the conductive housing 11 influenced by magnetic field. Further, a great effect of the electromagnetic force is brought about. Furthermore, material may generate stronger energy division and energy conversion due to the strong electromagnetic force. And in turn, quantum force is changed. Further, the change of the quantum force of the material may be quick and the effect thereof is made significant.

The balls 131 are made of heterogeneous material such as stainless steel of nonmetallic, conductive material. The magnetic induction of the permanent magnet 12 is measured to have a value of 2-6 gauss (G) so that an electromagnetic force can be generated in the housing 11. Also, rotation of the ball 131 may cut the electromagnetic field in the conductive housing 11 to bring about an effect of electromagnetic force. The pressure controller 112 may control an internal pressure of the housing 11 at a range between 4 and 16 pascal (Pa). The thermostat 111 may automatically regulating internal temperature of the housing 11 at a range between −20° C. and 100° C. A user may adjust environment parameters of the housing 11 based on properties of material so as to provide an optimum environment for changing quantum force of the material.

After the electric source has supplied electricity having a current of 0.1-4 ampere (A) and a voltage of 240-340 volt (V) to the housing 11 for conduction, the current and voltage of the housing 11 rotate the balls 131 to generate a magnetic force which affects time of quantum force change. A user may set both the current and the voltage can be set based on requirements.

After the electric source has supplied electricity having a current of 0.1-6 A and a voltage of 5-30V to each ball 131 for conduction, the current and voltage of the rotating ball 131 generates an electromagnetic force which affects time of quantum force change. A user may set both the current and the voltage can be set based on requirements.

The cooling unit 115 which is adapted to flow low temperature gas to the balls 131 so that temperature of each ball 131 may decrease to a range between 0° C. and −20° C. As such, temperature of the material having its electromagnetic force changed is dropped suddenly. The cooled material returns to a normal stable energy stage which can maintain stable properties. As a result, the material becomes an optimized material having stable properties after its quantum force has been changed.

By utilizing the apparatus 1 of the invention, after parameters have been set and material has been fed to the apparatus 1, the apparatus 1 is activated to cause particles of the material to change its quantum force. During the process, the parameters of the apparatus 1 can be adjusted to control a speed of the change of the quantum force.

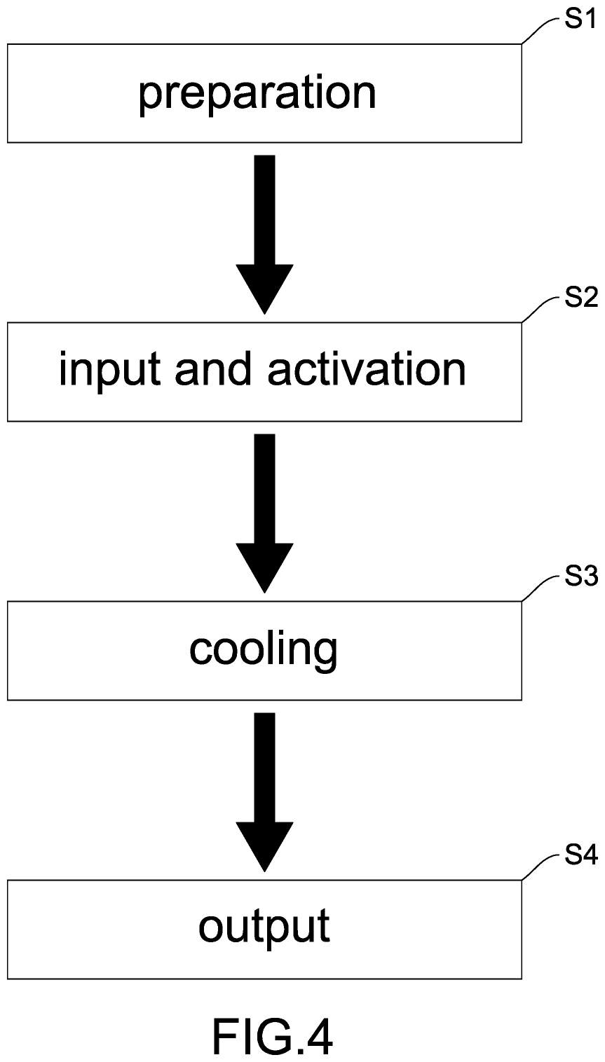

Referring to FIG. 4 in conjunction with FIG. 1, a flow chart of a method of cutting electromagnetic force, converting same and maintaining stable properties of the invention is illustrated. The method is tied to the apparatus 1 and comprises steps of S1 preparation, S2 input and activation, S3 cooling and S4 output as detailed below.

The step of S1 preparation involves setting parameters of the thermostat 111, the pressure controller 112, the emission unit 113 and the illumination unit 114 in the housing 11 of the apparatus 1; setting electrical parameters of the balls 131; and the electrical parameters of the housing 11 in which regarding the setting, the internal temperature of the housing 11 is regulated at a range between −20° C. and 100° C. and the internal pressure of the housing 11 is controlled at a range between 4 and 16 Pa; the current and the voltage of the housing 11 is set at 0.1-4 A and 240-340V respectively; and the current and the voltage of the ball 131 is set at 0-6 A and 5-30V respectively. These environment control parameters are preferably to cause the material to generate optimum change of quantum force.

The step of S2 input and activation involves after inputting the material (e.g., liquid or solid) to the apparatus 1, the apparatus 1 is activated. Next, in the apparatus 1, the thermostat 111 automatically regulates the internal temperature of the housing 11, the pressure controller 112 automatically controls the internal pressure of the housing 11, the emission unit 113 emits ultrasound toward the material, and the illumination unit 114 emits light toward the material. Thus, the permanent magnet 12 generates a magnetic field on an inner surface of the housing 11 and the balls 131 are conducted and rotate to cut the magnetic field to bring about a magnetic effect. The quantum force changes includes the energy of the material changed, cut, penetrated, separated, entangled and stacked due to the cutting of the magnetic field.

The step of S3 cooling involves after the set activation time has passed, the cooling unit 115 suddenly cools the balls 131 so that temperature of the material of the housing 11, which has been changed in quantum force, also suddenly decreases. The cooling unit 115 may cool the housing 11 to a temperature between 0° C. and −20° C. Thus, the cooled, quantum force changed material returns to a normal stable energy stage which can maintain stable properties.

The step of S4 output involves outputting the quantum force changed material having stable properties. As a result, the material becomes an optimized material having stable properties after its quantum force has been changed.

As shown in FIG. 1, by utilizing the apparatus 1 and application method thereof, a difference of rotational angles of the conductive balls 131, and a difference of rotational angle the conductive balls 131 rotating in different directions in the conductive housing 11 influenced by the magnetic field. Thus, an effect of electromagnetic force of the material is brought about by the conductive balls 131 and the conductive housing 11 influenced by the magnetic field. The effect of electromagnetic force causes particles of the material to change, cut, penetrate, separate, entangle and stack the energy of the material due to the cutting of the magnetic field. Thus, the material having quantum force changes is in an activated energy stage.

During the process of changing quantum force of the material, the thermostat 111 automatically regulates the internal temperature of the housing 11 to increase or decrease the speed of quantum force change of the material, the pressure controller 112 automatically controls the internal pressure of the housing 11 to be near vacuum to prevent the material from being interfered by impure particles in the air, the emission unit 113 emits ultrasound toward the material so that the material is further activated to facilitate the change of quantum force, and the illumination unit 114 emits light toward the material to change an energy structure of the particles of the material. Next, the cooling unit 115 suddenly decreases temperature of the activated material having its quantum force change so that the material returns to a stable energy stage which is an energy stage that can maintain stable properties. Finally, the material becomes an optimized material having stable properties after its quantum force has been changed.

By inputting the material to the apparatus 1 of the invention, the quantum force change of the material can be made quickly so that a material having stable properties is produced. And in turn, the process of changing quantum force can be carried out by setting and adjusting parameters. Further, an optimum control is carried out. In such a manner, the change of quantum force can be carried out by setting and adjusting parameters. Furthermore, the time and cost of changing properties of the liquid or solid material by changing quantum force can be optimized.

The following experiment is conducted by using wine as material. By utilizing the apparatus 1 and application method thereof and after parameters have been set, the wine is inputted into the apparatus. After one month has passed, the apparatus 1 is activated. Next, the apparatus 1 suddenly cooled to change quality of the wine. The wine having changed quality is finally outputted. A set number of people taste the wine having changed quality in a blind drink. Most people taking the taste say that the wine having changed quality is similar to wine stored for at least five years in terms of oral feel. It is concluded that the wine has become wine having its properties changed.

The apparatus and application method thereof of invention utilizing effect of the electromagnetic force to change the material in order to quickly become a quality changed material having stable properties has the following advantageous effects in comparison with the prior art:

It is capable of quickly changing quantum force of the material. Conditions for changing quantum force of a typical material are set at a higher standard and time for changing same is very long. The invention envisages that by setting parameters of the apparatus 1, the material is inputted to the apparatus 1 to activate, it is possible of changing the quantum force of the material in a short time, thereby shortening the time required for obtaining an optimized material having changed quantum force.

The change of the quantum force of the material can be controlled. The invention envisages that by setting parameters of the apparatus 1, the material is inputted to the apparatus 1 to activate, it is possible of changing the quantum force of the material. During the process, parameters of the apparatus 1 can be adjusted in order to control the speed of the change of quantum force.

While the invention has been described in terms of preferred embodiments, those skilled in the art will recognize that the invention can be practiced with modifications within the spirit and scope of the appended claims.

What is claimed is:

1. An apparatus for cutting electromagnetic force, converting same, and maintaining stable properties, comprising a housing and a rotational member wherein:
the housing is a multi-sided member and includes an environment control device and at least one permanent magnet each disposed on an inner surface of the housing;
the housing is formed of metallic conductive material;
the environment control device and the housing are electrically connected to an electric source;
the environment control device includes a thermostat for automatically regulating an internal temperature of the housing, a pressure controller for automatically controlling an internal pressure of the housing, an emission unit for emitting ultrasound, and an illumination unit for emitting light wherein the thermostat, the pressure controller, the emission unit, and the illumination unit are electrically connected to the electric source;
the thermostat is electrically connected to a cooling unit which is configured to flow low temperature gas to at least one ball to suddenly decrease a temperature of each of the at least one ball; and
the rotational member is disposed in the housing and electrically connected to the electric source; the rotational member is connected to each of the at least one ball which is conductive; and the rotational member is configured to control a rotation of each of the at least one ball and supply electricity thereto.

2. The apparatus of claim 1, wherein the number of the at least one ball is two; and the rotational member is configured to control rotations of the balls in opposite directions or the same direction.

3. The apparatus of claim 2, wherein each ball is formed of heterogeneous material.

4. The apparatus of claim 1, wherein a magnetic induction of the permanent magnet is measured to have an value of 2-6 gauss (G).

5. The apparatus of claim 1, wherein the pressure controller is configured to control an internal pressure of the housing at a range between 4 and 16 pascal (Pa).

6. The apparatus of claim 1, wherein the thermostat is configured to automatically regulate an internal temperature of the housing at a range between −20° C. and 100° C.

7. The apparatus of claim 1, wherein the electric source is configured to supply electricity having a current of 0.1-4 ampere (A) and a voltage of 240-340 volt (V) to the housing for conduction.

8. The apparatus of claim 1, wherein the electric source is configured to supply electricity having a current of 0.1-6 A and a voltage of 5-30V to each ball for conduction.

9. The apparatus of claim 1, wherein the cooling unit is configured to suddenly decrease a temperature of each ball to a range between 0° C. and −20° C.
